(19) United States
(12) Patent Application Publication
(10) Pub. No.: US 2024/0161092 A1
(43) Pub. Date: May 16, 2024

(54) CRYPTOGRAPHIC DIGITAL MEDIA AUTHENTICATION AND PROTECTION PROTOCOL

(71) Applicant: REV3AL LLC, Charlestown (KN)

(72) Inventors: Adam J. RUSSELL, Parkland, FL (US); Mohammed KURMARSI, Mission (CA)

(21) Appl. No.: 18/510,093

(22) Filed: Nov. 15, 2023

Related U.S. Application Data
(60) Provisional application No. 63/425,470, filed on Nov. 15, 2022.

(51) Int. Cl. G06Q 20/36; G06F 21/16; G06Q 20/38; G06Q 20/40

(52) U.S. Cl. CPC G06Q 20/3674; G06F 21/16; G06Q 20/3827; G06Q 20/401

(57) ABSTRACT

A method for authenticating a digital media file includes receiving a digital media file as input, generating a plurality of data points from the digital media file, storing the plurality of data points in a relational database, and creating a unique identifier (ID) by encrypting the plurality of data points using a one-way hashing function. The method also includes pinning the digital media file to the Inter Planetary File System (IPFS), creating a transaction timestamp and hash that is unique to the action of pinning the digital media file to a node on the IPFS, receiving the wallet address of an owner of the digital media file, generating a digital watermark comprising the unique ID, applying the digital watermark to the digital media file, creating a transaction record timestamp on a decentralized network of nodes, and storing the data points as a unique database record in a registry.

### RELATED APPLICATIONS

The present invention claims priority to Provisional Patent Application Ser. No. 63/425,470 filed Nov. 15, 2022, the entire contents of thereof incorporated herein by reference.

### TECHNICAL FIELD

The present invention relates to technology protection and authentication processes for digital media to include NFTs and virtual computer-generated environments, avatars and assets which utilize distributed and non-distributed ledger technology. The technology provides cryptographic identification, authentication and protection of digital media which may include NFTs located on gaming platforms, digital media platforms, NFT marketplaces, and virtual computer-generated environments such as a metaverse or video games.

### BACKGROUND

Computer security, cybersecurity (cyber security), or information technology security (IT security) is the protection of computer systems and networks from information disclosure, theft of, or damage to their hardware, software, or electronic data, as well as from the disruption or misdirection of the services they provide. Digital authentication is the process of authenticating and verifying the original status of a digital file, document or asset.

The field has become of significance due to the expanded reliance on computer systems, the Internet, and wireless network standards such as Bluetooth and Wi-Fi, and due to the growth of “smart” devices, including smartphones, televisions, and the various devices that constitute the Internet of things. Cybersecurity is also one of the significant challenges in the contemporary world, due to the complexity of information systems, both in terms of public or private usage and technology. Its primary goal is to ensure the system's dependability, integrity, and data privacy.

The current landscape of cybersecurity is designed to provide protection against computer viruses, malware, adware and other types of malicious content on the Internet and was largely created before the existence of distributed ledger technology such as the blockchain or hashgraph. With the advent of the commercial NFT industry and now increased investment and participation in the metaverse, these problems have changed with now the protection of valuable digital assets becoming a critical component of the Web3.0 digital economy and new ‘surfaces of attack’ emerging for bad actors and cybercriminals.

The problem is that it is very easy to duplicate and counterfeit a digital asset. Media assets are accessible via the Internet and tools are readily available. NFTs go some way to resolving the proof of ownership on the blockchain but do not provide proof of creation and it is very difficult to confirm the current creator of an NFT or digital media. Duplicated, counterfeited or misused digital media then proliferates and the current systems that exist are extremely complex, incomplete or non-agnostic and only work within enclosed digital ecosystems. There is no easy sustainable solution to stop duplicates of digital media being misused currently on NFT marketplaces, gaming platforms and virtual computer-generated environments such as the metaverse. In these environments there is no protection for a user's digital objects such as their digital avatar, digital accessories or digital real estate, all of which have both digital and real world value.

Therefore, what is needed is a method and system to authenticate digital media that overcomes the above-mentioned disadvantages.

### SUMMARY

A method for authenticating a digital media file is disclosed. The method includes receiving a digital media file as input, and generating a plurality of data points from the digital media file. The plurality of data points may include a hash of the digital media file, media file metadata, file owner information, transaction hash, and transaction timestamp. The method also includes storing the plurality of data points in a relational database, and creating a unique identifier (ID) by encrypting the plurality of data points using a one-way hashing function.

The method of registering the digital media file includes pinning the digital media file to the Inter Planetary File System (IPFS), creating a transaction timestamp and hash that is unique to the action of pinning the digital media file to a node on the IPFS, receiving the wallet address of an owner of the digital media file, and generating a digital watermark comprising the unique ID. In addition, the method includes applying the digital watermark to the digital media file, creating a transaction record timestamp on a decentralized network of nodes, and storing the unique ID, the IPFS time stamp, IPFS hash, HCS hash, and wallet address of the customer as a unique database record in a registry.

The method of authenticating the digital media file includes receiving the digital media file to be authenticated, detecting whether the digital watermark is present, and decrypting the digital water mark for an identifier to the unique database record that contains the plurality of data points associated with the digital media file. The method also includes comparing the data points revealed by the digital watermark to the unique database record that the digital watermark is purportedly associated, checking the transaction record timestamp to verify the transaction, and indicating that the digital media file is authentic when there is a match with the plurality of data points revealed by the digital watermark and the data points stored in the registry for the digital media file.

Another aspect is directed to a system for authenticating a digital media file. The system includes a processor, and a memory coupled to the processor to store instructions, which when executed by the processor, cause the processor to perform the operations comprising. The operations to register a digital media file include to receive a digital media file as input, and to generate a plurality of data points from the digital media file, wherein the plurality of data points comprises a hash of media file, media file metadata, file owner information, transaction hash, and transaction timestamp.

In addition, the operations to register a digital media file include to store the plurality of data points in a relational database, and to create a unique identifier (ID) by encrypting the plurality of data points using a one-way hashing function. The operations also include to pin the digital media file to the Inter Planetary File System (IPFS), create a transaction timestamp and hash that is unique to the action of pinning the digital media file to a node on the IPFS, receive the wallet address of an owner of the digital media file, and generate a digital watermark comprising the unique ID. The operations include to apply the digital watermark to the digital media file, create a transaction record timestamp on a decentralized network of nodes, and store the unique ID, the IPFS time stamp, IPFS hash, HCS hash, and wallet address of the customer as a unique database record in a registry.

The operations to authenticate the digital media file include to receive the digital media file to be authenticated, detect whether the digital watermark is present, decrypt the digital water mark for an identifier to the unique database record that contains the plurality of data points associated with the digital media file, and compare the data points revealed by the digital watermark to the unique database record that the digital watermark is purportedly associated. The operations to authenticate the digital media file also include to check the transaction record timestamp to verify the transaction, and to indicate that the digital media file is authentic when there is a match with the plurality of data points revealed by the digital watermark and the data points stored in the registry for the digital media file.

Yet another aspect is directed to non-transitory computer readable medium for authenticating a digital media file, and with the non-transitory computer readable medium having a plurality of computer executable instructions for causing the system to perform steps as described above.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram of a method to create a unique ID for a digital media file in accordance with the present disclosure of a cryptographic digital media authentication and protection protocol;

FIG. 2 is a block diagram of a method to register the unique ID and apply it to the digital media file in accordance with the present disclosure;

FIG. 3 is a block diagram of a method to authenticate the digital media file in accordance with the present disclosure; and

FIG. 4 is block diagram of a system to authenticate a digital media file.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention is directed to a protocol that, in a particular aspect, embeds an encrypted unique identifier (ID) or ‘follow me’ digital marker within the digital media asset itself. The unique ID allows for authentication and protection of digital media through a custom integration and/or an API. This is accomplished by creating the unique ID and a specific hash created with image forensic and distributed ledger consensus data that is then cross referenced and reconciled in a unique way on a non-distributed ledger to verify the assets authenticity throughout the lifecycle of the digital media.

The authentication process can be integrated at the digital media creation event or at any time during the life cycle of the digital media. This authentication is prior to minting or writing anything to the blockchain, making an NFT or digital media asset ‘platform agnostic’ across distributed and non-distributed ledger or hyper ledger technology or after the minting process.

The methods described herein may be applied across digital media assets in multiple formats and regardless of scale and can protect entire digital worlds whether it be Web2, web3, virtual computer-generated environments and/or metaverse/game environments. Fake or counterfeit assets, AI generated avatar ‘bots’ and cloned websites and environments can be authenticated and avoided or reported.

This is accomplished by utilizing a specific algorithm to detect the unique ID of the ‘follow me’ marker associated with that user's code as described below in more detail.

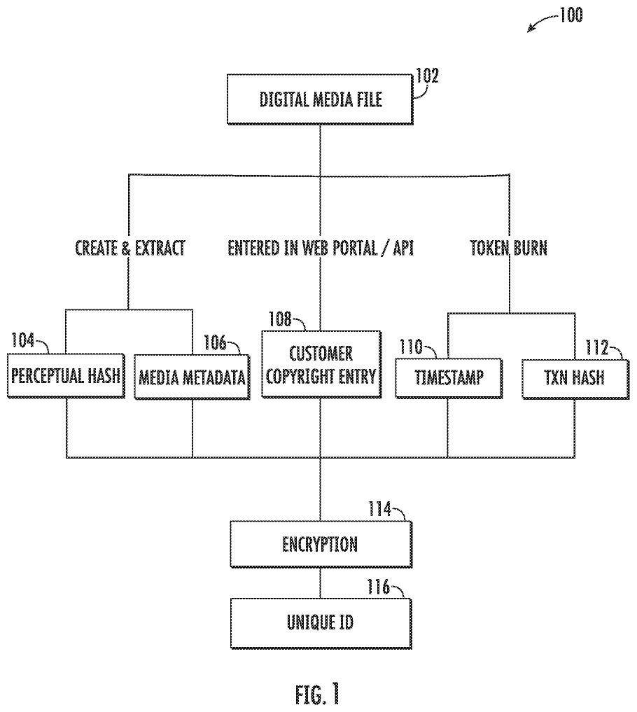

Referring now to FIG. 1, a method 100 to create the unique ID is generally designated 100. The method 100 begins by receiving a digital media file 102 as input, which is used for deriving multiple data points that are subsequently utilized in the creation of its unique ID. The data points include a hash of media file 104, media file metadata 106, file owner information 108, transaction hash 110, and transaction timestamp 112.

The method 100 includes securely storing the data points in a relational database, then combining them for creating the unique ID 116. The unique ID 116 comprises a hashed string produced by a one-way hashing function 114.

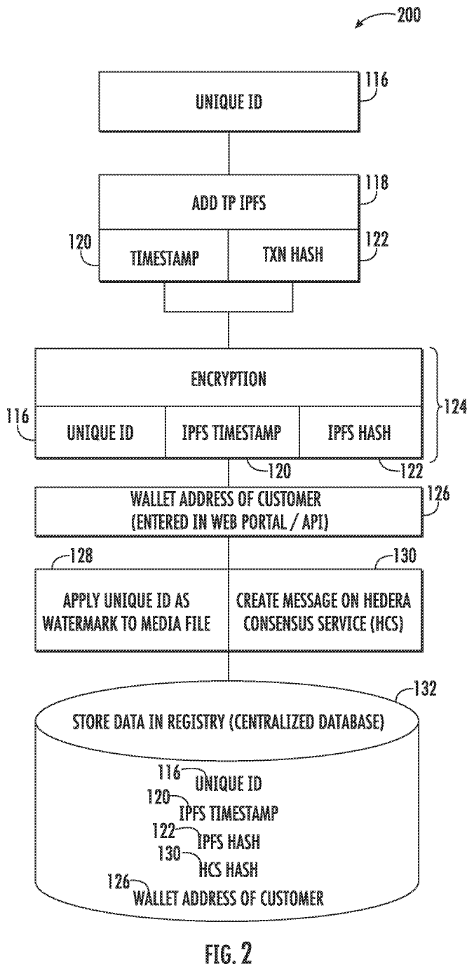

Referring now to FIG. 2, once the unique ID 116 has been created then the method moves to registering the unique ID 200. A purpose of registering the unique ID is to create a database record that contains the unique ID, along with additional data points that can be stored on decentralized networks and used in the future when verifying the authenticity of a digital media file 102.

The method 200 of registering the unique ID 116 includes pinning the digital media file 102 to the Inter Planetary File System (IPFS) 118. The method 200 also includes creating a transaction timestamp 120 and hash 122 that is unique to the action of pinning the digital media file 102 to a node on the IPFS at 124. The wallet address 126 of the owner of the digital media file 102 is also captured by the method 200, identifying yet another data point that is used to build a relationship between the digital media file data and the time in which specific actions pertaining to the file have occurred. This relationship takes the iconic form of a digital watermark 128 comprising the unique ID 116, that is applied to the digital media file 102 itself.

In-parallel to applying the digital watermark 128, another transaction record is created on a 3rd-party, decentralized network of nodes (e.g., a HCS timestamp). This transaction can be referenced during future attempts to authenticate a digital media file with the present method and system and provides a verifiable source of consensus to the authentication process in a bias-free manner.

Accordingly, as a final step in registering the unique ID, a centralized database, or registry 132, is populated with the aforementioned data points, comprising a unique database record and source of verification for information pertaining to digital media files that have been registered with and secured by method and system.

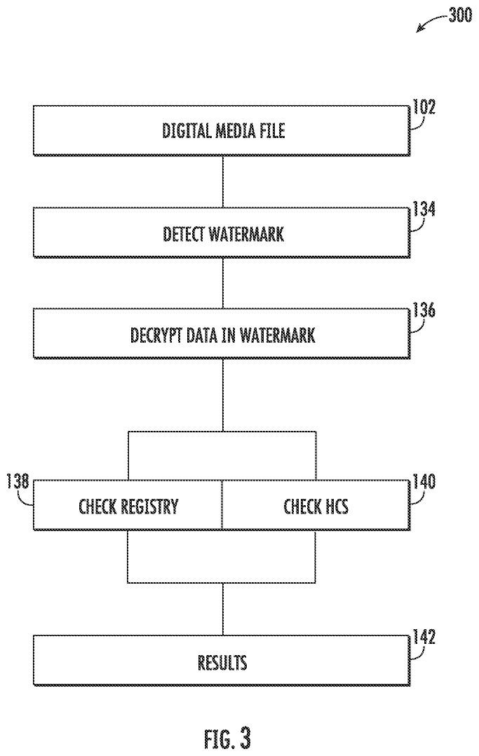

Referring now to FIG. 3 a method 300 of verifying the digital media file 102 is depicted. The method 300 includes accessing the database of unique data points stored in the registry 132 so that a user may verify the authenticity of the digital media file 102.

The method 300 begins with the user submitting the digital media file 102 to be authenticated and detecting whether the digital watermark is present 134. If the digital watermark is detected, then the data in the watermark is decrypted, at 136. The digital watermark serves as an identifier to the unique database record that contains the numerous data points previously described above for the digital media file 102.

The method 300 includes comparing the data points revealed by the digital watermark to the unique database record that the digital watermark is purportedly associated, at 138. In addition, the method 300 also checks the HCS timestamp, at 140, to verify the transaction record on 3^{rd} party decentralized network of nodes. If there is a match with the data points revealed by the digital watermark and the data points stored in the registry 132 for the digital media file 102, and also there is a match with the HCS hash, then the digital media file 102 is indicated as authentic, at 142. Otherwise, the digital media file 102 and associated digital watermark are indicated as not authentic, at 142, when there is not a complete match of the data points.

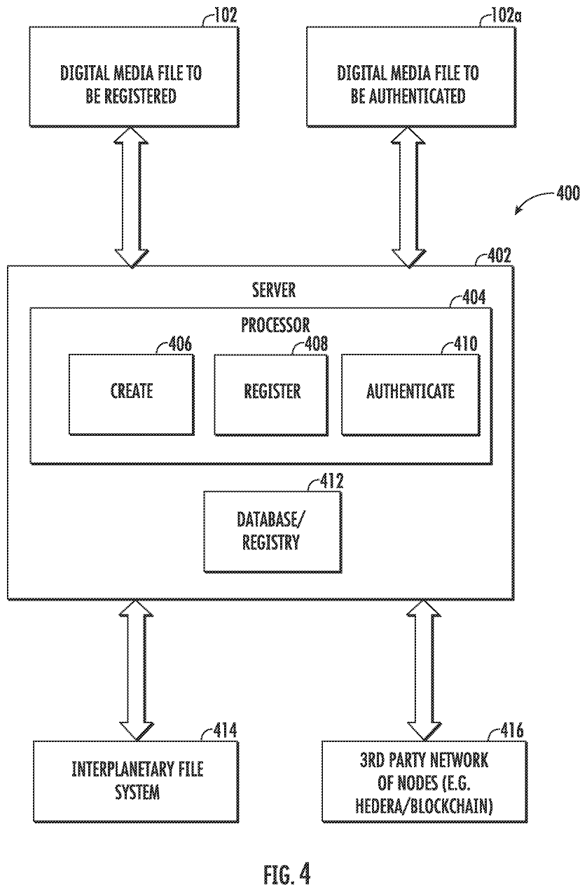

Referring now to FIG. 4, a system to authenticate a digital media file is depicted and generally designated 400. The system 400 includes a server 402 or similar device as those of ordinary skill in the art can appreciate. The processor 404 may include one or more microprocessors, ASICs or SOCs. The system 400 also includes one or more modules 406, 408, 410 configured to create the unique ID described above, register the digital media file 102, and to authenticate the digital media file 102a using various algorithms and/or artificial intelligence and machine learning. The system 400 includes a memory 412 comprising a database or registry for storing the data points for a data media file 102 used to authenticate the submitted digital media file 102. In addition, the system 400 is in communication with the Interplanetary File System 414 and third party network of nodes such as Hedera, for example, which are used to further generate data points of timestamps for a digital media file 102.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method for authenticating a digital media file, the method comprising:
receiving a digital media file as input;
generating a plurality of data points from the digital media file, wherein the plurality of data points comprises a hash of media file, media file metadata, file owner information, transaction hash, and transaction timestamp;
storing the plurality of data points in a relational database; and
creating a unique identifier (ID) by encrypting the plurality of data points using a one-way hashing function.

2. The method of claim 1, further comprising:
pinning the digital media file to the Inter Planetary File System (IPFS);
creating a transaction timestamp and hash that is unique to the action of pinning the digital media file to a node on the IPFS;
receiving the wallet address of an owner of the digital media file;
generating a digital watermark comprising the unique ID;
applying the digital watermark to the digital media file;
creating a transaction record timestamp on a decentralized network of nodes; and
storing the unique ID, the IPFS time stamp, IPFS hash, HCS hash, and wallet address of the customer as a unique database record in a registry;

3. The method of claim 2, further comprising:
receiving the digital media file to be authenticated;
detecting whether the digital watermark is present;
decrypting the digital water mark for an identifier to the unique database record that contains the plurality of data points associated with the digital media file;
comparing the data points revealed by the digital watermark to the unique database record that the digital watermark is purportedly associated;
checking the transaction record timestamp to verify the transaction; and
indicating that the digital media file is authentic when there is a match with the plurality of data points revealed by the digital watermark and the data points stored in the registry for the digital media file.

4. A non-transitory computer readable medium storing a plurality of instructions executable by one or more processors, the plurality of computer executable instructions when executed by the one or more processors cause the one or more processors to:
receive a digital media file as input;
generate a plurality of data points from the digital media file, wherein the plurality of data points comprises a hash of media file, media file metadata, file owner information, transaction hash, and transaction timestamp;
store the plurality of data points in a relational database; and
create a unique identifier (ID) by encrypting the plurality of data points using a one-way hashing function;

5. The non-transitory computer readable medium of claim 4, further comprising executable instructions when executed by the one or more processors cause the one or more processors to:
pin the digital media file to the Inter Planetary File System (IPFS);
create a transaction timestamp and hash that is unique to the action of pinning the digital media file to a node on the IPFS;
receive the wallet address of an owner of the digital media file;
generate a digital watermark comprising the unique ID;
apply the digital watermark to the digital media file;
create a transaction record timestamp on a decentralized network of nodes; and
store the unique ID, the IPFS time stamp, IPFS hash, HCS hash, and wallet address of the customer as a unique database record in a registry;

6. The non-transitory computer readable medium of claim 4, further comprising executable instructions when executed by the one or more processors cause the one or more processors to:
receive the digital media file to be authenticated;
detect whether the digital watermark is present;
decrypt the digital water mark for an identifier to the unique database record that contains the plurality of data points associated with the digital media file;
compare the data points revealed by the digital watermark to the unique database record that the digital watermark is purportedly associated;
check the transaction record timestamp to verify the transaction; and
indicate that the digital media file is authentic when there is a match with the plurality of data points revealed by the digital watermark and the data points stored in the registry for the digital media file.

7. A system for authenticating a digital media file, the system comprising:
a processor; and
a memory coupled to the processor to store instructions, which when executed by the processor, cause the processor to perform the operations comprising:
receive a digital media file as input;
generate a plurality of data points from the digital media file, wherein the plurality of data points comprises a hash of media file, media file metadata, file owner information, transaction hash, and transaction timestamp;
store the plurality of data points in a relational database; and
create a unique identifier (ID) by encrypting the plurality of data points using a one-way hashing function;

8. The system of claim 7, wherein the operations further comprise:
pin the digital media file to the Inter Planetary File System (IPFS);
create a transaction timestamp and hash that is unique to the action of pinning the digital media file to a node on the IPFS;
receive the wallet address of an owner of the digital media file;
generate a digital watermark comprising the unique ID;
apply the digital watermark to the digital media file;
create a transaction record timestamp on a decentralized network of nodes; and
store the unique ID, the IPFS time stamp, IPFS hash, HCS hash, and wallet address of the customer as a unique database record in a registry;

9. The system of claim 8, wherein the operations further comprise:
receive the digital media file to be authenticated;
detect whether the digital watermark is present;
decrypt the digital water mark for an identifier to the unique database record that contains the plurality of data points associated with the digital media file;
compare the data points revealed by the digital watermark to the unique database record that the digital watermark is purportedly associated;
check the transaction record timestamp to verify the transaction; and
indicate that the digital media file is authentic when there is a match with the plurality of data points revealed by the digital watermark and the data points stored in the registry for the digital media file.
